(19) United States
(12) Patent Application Publication
(10) Pub. No.: US 2026/0255222 A1
(43) Pub. Date: Aug. 27, 2026

(54) METHOD, DEVICE, AND MEDIUM FOR ADJUSTING NETWORK QUALITY OF SERVICE

(71) Applicant: Verizon Patent and Licensing Inc., Basking Ridge, NJ (US)

(72) Inventors: Lixia Yan, Basking Ridge, NJ (US); Brendan Major, Randolph, NJ (US); Javier A. Ferro, Somerset, NJ (US)

(21) Appl. No.: 19/063,537

(22) Filed: Feb. 26, 2025

(51) Int. Cl. H04W 28/24; H04L 12/14; H04W 28/02

(52) U.S. Cl. CPC H04W 28/24; H04L 12/1407; H04W 28/0268

(57) ABSTRACT

A method, a network device, and a non-transitory computer-readable storage medium are described in relation to a QoS adjustment service. An access device in a radio access network (RAN) determines that an assigned quality of service (QoS) level for a session or flow cannot be fulfilled by the access network. The access device sends, to a network device, a notification message with a recommended QoS level that can be supported by the access device. The network device assigns an updated QoS level for the session based on the recommended QoS level. The access device receives and applies the updated QoS level for the session or flow based on the recommended QoS level.

### BACKGROUND

Development and design of networks present certain challenges from a network perspective and an end device perspective. With respect to Fourth Generation (4G) and Next Generation (NG) wireless networks, such as Fifth Generation New Radio (5G NR) networks, various mechanisms and technologies may be used to ensure the delivery of certain performance requirements, such as minimal latency and packet loss, as well as high throughput and other types of network performance criteria.

### BRIEF DESCRIPTION OF THE DRAWINGS

FIG. 1 is a diagram illustrating an exemplary environment in which an embodiment of a Quality of Service (QoS) adjustment service may be implemented;

FIG. 2 is a messaging diagram illustrating an exemplary process of an embodiment of the QoS adjustment service;

FIG. 3 is a messaging diagram illustrating another exemplary process of an embodiment of the QoS adjustment service;

FIG. 4 is a diagram illustrating exemplary components of a device that may correspond to one or more of the devices illustrated and described herein;

FIG. 5 is a flow diagram illustrating an exemplary process of an embodiment of the QoS adjustment service; and

FIG. 6 is a flow diagram illustrating another exemplary process of an embodiment of the QoS adjustment service.

### DETAILED DESCRIPTION

The following detailed description refers to the accompanying drawings. The same reference numbers in different drawings may identify the same or similar elements. Also, the following detailed description does not limit the invention.

A protocol data unit (PDU) session or a packet data network (PDN) session may refer to a connection between a user equipment (UE) device and another endpoint, such as data network (DN). The quality-of-service (QoS) level for a PDU session or PDN session is determined by a core network device, such as a policy control function (PCF) or a policy and charging rules function (PCRF). The core network and radio access network (RAN, such as a 5G NR network or 4G RAN) follow the instructions from the PCF/PCRF and allocate resources to meet the specified QoS requirements. However, it is possible that RAN devices (e.g., a next-generation NodeB (gNB) or evolved NodeB (eNB)) become overloaded and unable to fulfill the QoS determined by the PCF/PCRF.

In 5G networks, a UE device may establish one or more data flows in a PDU session. A QoS flow, also called a dedicated flow, refers to a data flow having specific QoS requirements, which may be mapped to network resources. The QoS level for QoS flow is typically determined by an application function (AF), which provides instructions relative to a specific QoS flow for the core network and RAN to follow. For example, the AF may support an application (e.g., gaming, interactive video, augmented reality, etc.) with minimum performance requirements for a dedicated flow.

Standards, such as Third Generation Partnership Project (3GPP), 3GPP2, International Telecommunication Union (ITU), European Telecommunications Standards Institute (ETSI), GSM Association (GSMA), or the like, may define mechanisms to allow the RAN to report to the core network when a requested QoS level cannot be fulfilled. Upon receiving a “QoS not fulfilled” report, network devices typically have two options: either terminate the problematic session/QoS flow or downgrade the session/flow to a new QoS level. In many instances, downgrading to a new QoS level may be the preferred option. However, a challenge arises as the core network may lack sufficient information or knowledge to determine the appropriate new QoS level. As a result, it is possible that the new QoS proposed by the PCF/PCRF/AF may still be impossible for the RAN to implement, leading to further problems.

Implementations described herein provide a QoS adjustment service that allows the core network to adjust QoS based on a RAN recommendation. The QoS adjustment service may ensure that any updated QoS directed by core network devices (e.g., PCF/PCRF) or application functions will be acceptable and supported at the gNB/eNB (collectively referred to herein as access devices) in the RAN. For example, when an access device cannot fulfill a QoS request for a session or dedicated flow, the access device may trigger a modified “QoS not fulfilled” event at the core network. The modified “QoS not fulfilled” trigger, which may be in the form of an information element (IE), may include a recommended QoS level based on the current available resources and capacity of the access device. The recommended QoS level may be passed from the access device to the core network and to the appropriate PCF/PCRF or AF. Using the recommended QoS level, the PCF/PCRF or AF can update the QoS level for the session or dedicated flow. Since the updated QoS level will be derived from the access device's capacity-based recommendation, the access device is assured of having the necessary resources to support the updated QoS.

According to various implementations, the access device determines that an assigned quality of service (QoS) level for a session or flow cannot be fulfilled by the access network. For example, the access device may detect that a PDU session, a bearer of a PDN session, or a QoS flow of a PDU session cannot be fulfilled. The access device identifies a recommended QoS level and sends, to a network device (e.g., the PCF or PCRF) in a core network, a notification message with the recommended QoS level that can be supported by the access device. The recommended QoS level may include, for example, a 5G QoS Identifier (5 QI), a QoS Class Identifier (QCI), an Allocation and Retention Priority (ARP) level, and/or load information indicative of a current capability of the access device to support the session or flow. The recommended QoS level may be included in an information element of the notification message. The network device assigns an updated QoS level for the session based on the recommended QoS level. The access device receives and applies the updated QoS level for the session or flow based on the recommended QoS level.

In view of the foregoing, the QoS adjustment service may enable adjustment of QoS levels in a more definitive manner based on access device load conditions and capabilities, as described herein. Additionally, the QoS adjustment service may reduce backend signaling when the RAN is unable to meet the originally assigned QoS. Furthermore, the AFs may be better informed as to whether a current flow for an application can be continued or terminated.

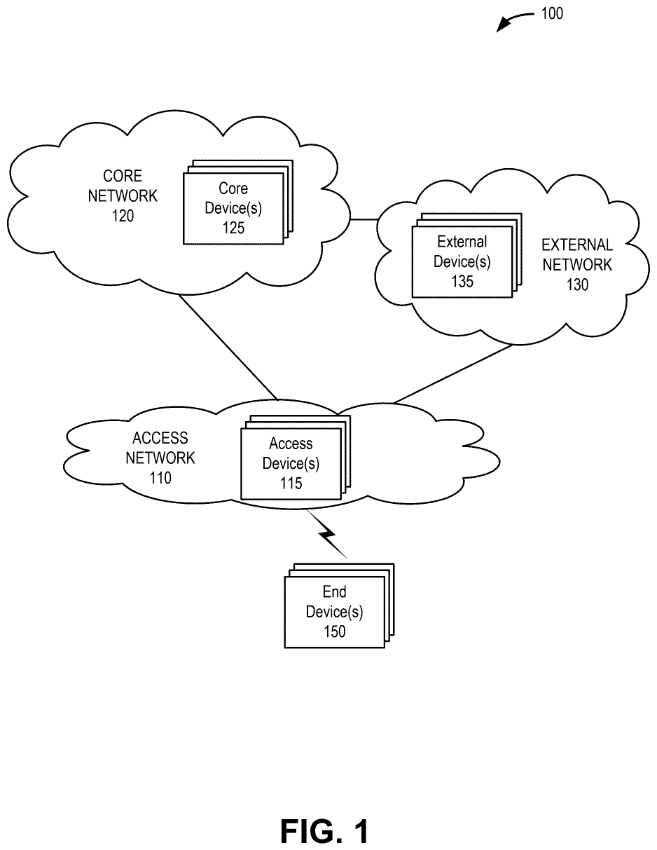

FIG. 1 is a diagram illustrating an exemplary environment 100 in which an embodiment of the QoS adjustment service may be implemented. As illustrated, environment 100 includes an access network 110, a core network 120, and an external network 130. Access network 110 includes access devices 115 (also referred to individually or generally as access device 115). Core network 120 includes core devices 125 (also referred to individually or generally as core device 125). External network 130 includes external devices 135 (also referred to individually or generally as external device 135). Environment 100 further includes end devices 150 (also referred to individually or generally as end device 150).

The number, type, and arrangement of networks illustrated in environment 100 are exemplary. For example, according to other embodiments, environment 100 may include fewer networks, additional networks, and/or different networks. For example, according to other embodiments, other networks not illustrated in FIG. 1 may be included, such as an X-haul network (e.g., backhaul, mid-haul, fronthaul, etc.), a transport network, or another type of network that may support a wireless service and/or an end device application service, as described herein.

A network device, a network element (NE), or a network function (NF) (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, etc.), as well as used to support other types of network elements (e.g., network slices, QoS flows, PDU sessions, PDN sessions, channels, network paths, tunnels, etc.).

Environment 100 includes communication links between the networks and between the network devices. Environment 100 may be implemented to include wired, optical, and/or wireless communication links. A communication link or connection may be direct or indirect. For example, an indirect communicative connection may involve an intermediary device and/or an intermediary network not illustrated in FIG. 1. A direct communication connection may not involve an intermediary device and/or an intermediary network.

Environment 100 may include various planes of communication including, for example, a control plane, a user plane, a service plane, and a network management plane. Environment 100 may include other types of planes of communication. A message communicated in support of the QoS adjustment service may use at least one of these planes of communication. According to various implementations, the interface of the network device may be a service-based interface, a reference point-based interface, an Open Radio Access Network (O-RAN) interface, a 5G interface, another generation of interface (e.g., 5G Advanced, Sixth Generation (6G), Seventh Generation (7G), etc.), or some other type of network interface (e.g., proprietary, etc.).

Access network 110 may include one or multiple networks of one or multiple types and technologies. For example, access network 110 may be implemented to include a 5G RAN, a future generation RAN (e.g., a 6G RAN, a 7G RAN, etc.), a centralized-RAN (C-RAN), a virtualized RAN (vRAN), an Open-RAN (O-RAN), and/or another type of access network. Access network 110 may include a legacy RAN (e.g., a Third Generation (3G) RAN, a Fourth Generation (4G) RAN, etc.).

Access network 110 may include different and multiple functional splitting, such as options 1, 2, 3, 4, 5, 6, 7, or 8 that relate to combinations of access network 110 and core network 120 including an Evolved Packet Core (EPC) network and/or a Next Generation Core (NGC)/5G core network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), as well as other types of network services, such as dual connectivity (DC), carrier aggregation (CA), edge and core network slicing, coordinated multipoint (CoMP), various duplex schemes, and/or another type of connectivity service (e.g., NSA NR, SA NR, etc.).

Depending on the implementation, access network 110 may include one or multiple types of network devices, such as access devices 115. For example, access device 115 may include a gNB, an enhanced LTE (eLTE) eNB, an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN gNB, O-RAN-eNB), a 5G ultra-wide band (UWB) node, and/or a future generation wireless access device (e.g., a 5G advanced wireless station, a 6G wireless station, a 7G wireless station, or another generation of wireless station). Access devices 115 may include a transport device (e.g., a router or similar network device).

According to some implementations, access device 115 may include a combined functionality of multiple Radio Access Technologies (RATs) (e.g., 4G and 5G functionality, 5G and 5G Advanced functionality, 5G and 6G), etc.) via soft and hard bonding based on demands and needs. According to some implementations, access device 115 may include a split access device (e.g., a CU-control plane (CP), a CU-user plane (UP), etc.) or an integrated functionality, such as a CU-CP and a CU-UP, or other integrations of split RAN nodes. Access device 115 may be an indoor device or an outdoor device.

According to some embodiments, at least some of access devices 115, as described herein, include an exemplary embodiment of the QoS adjustment service. For example, according to an embodiment, a gNB, eNB, or similar type of access device may include logic of the QoS adjustment service. According to such an embodiment, access device 115 may be equipped to associate its current capabilities and load levels with a QoS level (e.g., a 5G QoS Identifier (5 QI), a QoS Class Identifier (QCI), etc.) or another indicator (e.g., Allocation and Retention Priority (ARP) level, load/capacity information, etc.) indicative of a current capability of access device 115 to support a PDU/PDN session (referred to generically herein as a session) or dedicated flow. Access device 115 may identify and provide recommended QoS levels to core devices, as described further herein. For example, an access device 115 may be configured to identify a highest QoS level that can currently be supported for a session/flow when the originally assigned QoS cannot be fulfilled.

Core network 120 may include one or multiple networks of one or multiple network types and technologies. Core network 120 may include a complementary network of access network 110. For example, core network 120 may be implemented to include a 5G core network, an evolved packet core (EPC) of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation, core network 120 may include diverse types of core devices 125. Core devices 125 may include, for example, an access and mobility management function (AMF), a session management function (SMF), a policy control function (PCF), a network exposure function (NEF), a unified data management (UDM) device, a unified data repository (UDR), a user plane function (UPF), a Non-3GPP Interworking Function (N3IWF), an authentication server function (AUSF), a security anchor function (SEAF), a network slice selection function (NSSF), a network repository function (NRF), a network data analytics function (NWDAF), a mobility management entity (MME), a packet data network gateway (PGW), a serving gateway (SGW), and/or a policy and charging rules function (PCRF).

According to other implementations, core devices 125 may include additional, different, and/or fewer network devices than those described. For example, core devices 125 may include a non-standard or a proprietary network device, and/or another type of network device that may be well-known but not particularly mentioned herein. Core devices 125 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes. Also, core devices 125 may include a split core device 125. For example, core devices 125 may include a session management (SM) PCF, an access management (AM) PCF, a user equipment (UE) PCF, and/or another type of split architecture associated with another core device 125, as described herein.

External network 130 may include one or multiple networks of one or multiple types and technologies that provide an application service. For example, external network 130 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 130 may be implemented to include a cloud network, a private network, a public network, a Multi-access Edge Computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 130 may include various network devices, such as external devices 135. For example, external devices 135 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 150. By way of further example, external devices 135 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 130 may include one or multiple types of core devices 125, as described herein.

External devices 135 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services.

End device 150 may include a device that may have communication capabilities (e.g., wireless, wired, optical, etc.). End device 150 may or may not have computational capabilities. End device 150 may be implemented as a mobile device, a portable device, a stationary device (e.g., a non-mobile device and/or a non-portable device), a device operated by a user, or a device not operated by a user. For example, end device 150 may be implemented as a smartphone, a mobile phone, a personal digital assistant, a tablet, a netbook, a wearable device (e.g., a watch, glasses, headgear, a band, etc.), a computer, a gaming device, a music device, an Internet-of-Things (IoT) device, a drone, a smart device, an autonomous vehicle, or another type of wireless device (e.g., another type of UE). End device 150 may or may not be configured to execute diverse types of software (e.g., applications, programs, etc.). The types of software may vary among end devices 150. End device 150 may include “edge-aware” and/or “edge-unaware” application service clients. End device 150 may be implemented as a virtualized device in whole or in part. For purposes of description, end device 150 is not considered a network device.

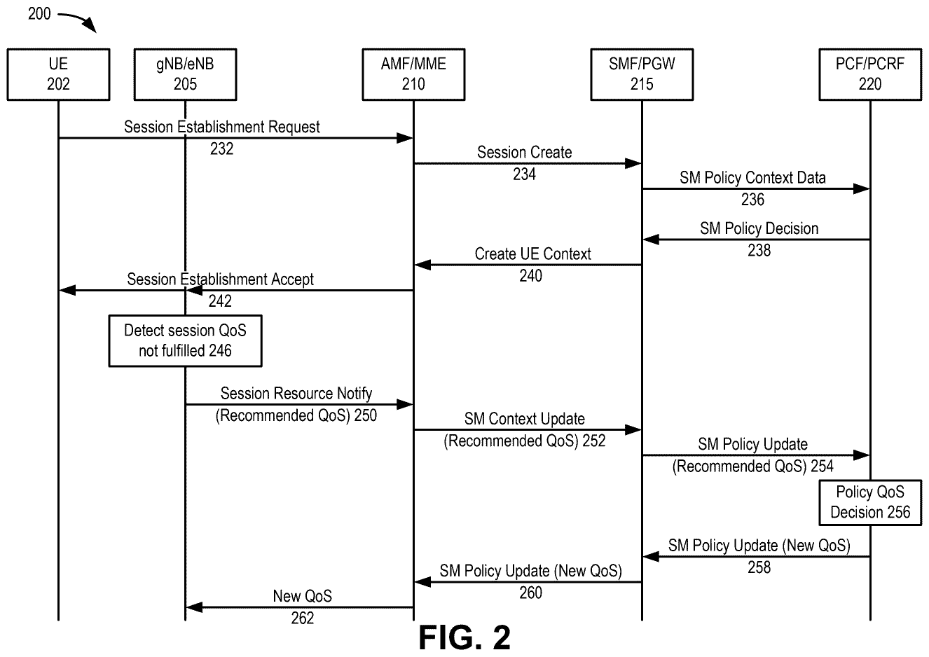

FIG. 2 is a messaging diagram illustrating an exemplary process 200 of an embodiment of the QoS adjustment service. Process 200 describes messages relating to adjusting a QoS level for a PDU session or PDN session. As illustrated, process 200 may involve exemplary network devices, such as a gNB/eNB 205, an AMF/MME 210, an SMF/PGW 215, and a PCF/PCRF 220. Each of gNB/eNB 205, AMF/MME 210, SMF/PGW 215, and PCF/PCRF 220 may represent functions for corresponding 5G/4G core network components. Process 200 may further involve a UE 202, which is an implementation of end device 150. The gNB/eNB 205 may correspond to an access device 115, while AMF/MME 210, SMF/PGW 215, and PCF/PCRF 220 may correspond to core devices 125. In one implementation, PCF/PCRF 220 may be implemented with a split architecture, where an SM-PCF performs aspects of process 200. According to other embodiments, process 200 may involve fewer, different, or additional network devices.

The messages illustrated and described are exemplary. Additionally, any protocol suggested by the form of a message is exemplary and not intended to limit the embodiment of the QoS adjustment service. For example, some of the messages illustrated and described may include use of the Hypertext Transfer Protocol (HTTP) in which certain request methods (e.g., GET, POST, etc.) may be used. However, according to other embodiments, such messages may be implemented by a protocol other than HTTP or a version thereof.

FIG. 2 provides simplified illustrations of communications and is not intended to reflect every signal or message exchanged between devices/functions. Accordingly, in practice, additional messages may be exchanged and additional core devices 122 may be involved, for example, in the session establishment procedure and QoS update procedure.

UE 202, gNB/eNB 205, AMF/MME 210, SMF/PGW 215, and PCF/PCRF 220 may each include logic that performs an operation or provides a function that is in accordance with a technical specification associated with a network standardizing body, such as 3GPP, 3GPP2, ITU, ETSI, GSMA, or the like. According to some embodiments, UE 202, gNB/eNB 205, AMF/MME 210, SMF/PGW 215, and PCF/PCRF 220 or a sub-combination thereof, may be configured with logic that provides a proprietary operation or function not specified by the network standard. Additionally, gNB/eNB 205, AMF/MME 210, SMF/PGW 215, and PCF/PCRF 220 may each include logic of the QoS adjustment service, as described herein.

Referring to FIG. 2, after an initial registration and/or attachment procedure (not shown), UE 202 may generate and transmit a session establishment request 232 to AMF/MME 210. Session establishment request 232 may include, among other data, a session identifier, a UE requested data network name (DNN)/packet data network (PDN), and so forth. In the example of FIG. 2, assume session establishment request 232 may include PDU Session ID=1 and DNN=WirelessInternet.

In response to receiving request 232, AMF/MME 210 may read request 232 and, in response, may generate and transmit a session create request 234 to SMF/PGW 215. Session create request 234 may include the session (e.g., PDU Session ID=1) and the requested DNN (e.g., DNN=WirelessInternet), for example, among other instances of data. For example, session create request 234 may be in the form of an HTTP POST message (e.g., POST../nsmf-pdusession/v./sm-contexts (SmContextCreateData)).

In response to session create request 234, SMF/PGW 215 may perform an SM policy association establishment procedure with PCF/PCRF 220, which may include generating and transmitting an SM policy association message 236. SM policy association message 236 may include the selected session ID and DNN, among other types of information. For example, SM policy association message 236 may be in the form of an HTTP POST message (e.g., POST../sm-policies (SmPolicyContextData)).

PCF/PCRF 220 may receive and analyze SM policy association message 236. In response, PCF/PCRF 220 may determine the QoS that the session is authorized to use and may provide a policy decision message 238 to SMF/PGW 215. For example, PCF/PCRF 220 may access a subscriber database (not shown) to obtain subscription information associated with UE 202. Policy decision message 238 may contain a QoS profile, including a 5 QI (e.g., 5 QI=5), an Allocation and Retention Priority (ARP) value that defines a relative importance of the data flow in light of resource limitations (e.g., ARP=11), and/or other types of QoS parameters. For example, policy decision message 238 may be in the form of an HTTP success message (e.g., 201 Created (SmPolicyDecision), QoS={5 QI=5, ARP=11}). According to one implementation, the QoS profile in policy decision message 238 may also include a policy control request trigger for indicating when the assigned QoS parameters are not met (e.g., PolicyControlRequestTrigger=QoS_Notif).

SMF/PGW 215 may receive policy decision message 238. In response, SMF/PGW 215 may direct the policy decision to AMF/MME 210 and gNB/eNB 205 with other session parameters. For example, SMF/PGW 215 may forward to AMF/MME 210 a create UE context message 240 that includes the session ID (e.g., PDU Session ID=1), the requested DNN (e.g., DNN=WirelessInternet), and the QoS profile from policy decision message 238. For example, the create UE context message 240 may be in the form of an HTTP POST message (e.g., POST../namf-comm/v./ue-contexts/{ueContextId}/n1-n2-messages). In one implementation, create UE context message 240 may include an information element (IE) with N2 SM information for the QoS profile (e.g., PDU Session Resource Setup Request Transfer IE (PDU Session ID=1, 5 QI=5, QoS Profile)).

AMF/MME 210 may receive message 240 and, in response, establish the session. For example, AMF/MME 210 may provide an initial context setup message 242 including an IE with the QoS profile (e.g., PDU Session Resource Setup Request Transfer IE (PDU Session ID=1, 5 QI=5, QoS Profile)). The gNB/eNB 205 may establish the session with UE 202 and may facilitate the session according to the assigned QoS profile.

Once the session is established, gNB/eNB 205 ensures that the assigned QoS from PCF/PCRF 220 is applied to the session. At some point after the session is established, gNB/eNB 205 may determine that it can no longer fulfill the original assigned QoS, as indicated at reference 246. For example, gNB/eNB 205 may have insufficient resources to support current network loads. Accordingly, gNB/eNB 205 may generate and send a session resource notify message 250 to AMF/MME 210. Session resource notify message 250 may include, for example, a session ID (e.g., PDU Session ID=1), an IE for a PDU Session Resource Notify Transfer. In one implementation, the IE may include a notification cause (e.g., QoS not fulfilled), and a recommended QoS that can be supported by the gNB/eNB (e.g., Recommend QoS of 5 QI=6, instead of the originally assigned 5 QI=5). In other implementations, gNB/eNB 205 may recommend a different QoS level (e.g., a downgrade of multiple 5 QI levels).

AMF/MME 210 may receive session resource notify message 250 and, in response, may forward the notify message to SMF/PGW 215. In one implementation, AMF/MME 210 may forward the notify message in an SM context update message 252 to SMF/PGW 215. SM context update message 252 may include the notification cause and the recommended QoS (e.g., 5 QI=6) from gNB/eNB 205. For example, SM context update data message 252 may be in the form of an HTTP POST message (e.g., POST../SM-CONTEXTS/{smContextRef}/modify (SmContextUpdateData)). An IE of SM context update data message 252 may include the notification and recommendation from gNB/eNB 205 (e.g., N2SmInfo=PDU Session Resource Notify Transfer {QFI=5, Notification Cause=not fulfilled, Recommend QoS={5 QI=6}).

SMF/PGW 215 may receive SM context update data message 252 and, in response, provide a SM policy update message 254 to PCF/PCRF 220. SM policy update message 254 may include, among other information, a QoS not guaranteed indicator, the notification cause, and the recommended QoS (e.g., 5 QI=6) from gNB/eNB 205. For example, SM policy update message 254 may be in the form of an HTTP POST message (e.g., POST../sm-policies/{SmpolicyID}/update). An IE of SM policy update message 254 may include a notification trigger (e.g., repPolicyCtrlReqTriggers=QoS_Notif) along with the recommended QoS (e.g., qncReports={notifType=NOT_GUARANTEED, refPccRuleIds=xx, Recommend QoS={5 QI=6} }).

PCF/PCRF 220 may receive SM policy update message 254 and, in response, make a decision 256 to adjust the QoS for the session. PCF/PCRF 220 can make the decision to either terminate the existing session or update the QoS of the existing session to a lower value. According to implementations described herein, when electing to update the QoS of the existing session, PCF/PCRF 220 may take into account the recommended QoS level provided by gNB/eNB 205 (e.g., 5 QI=6). For example, PCF/PCRF 220 may assign a new QoS value that is of equal or lower priority than the QoS level recommended by gNB/eNB 205. Thus, PCF/PCRF 220 may make an informed decision when adjusting the QoS for the session.

PCF/PCRF 220 may provide an SM policy update message 258 with a newly assigned QoS level to SMF/PGW 215. In one implementation, SM policy update message 258 may be in the form of an HTTP 200 OK message with the new QoS level. SMF/PGW 215 may receive SM policy update message 258 and, in response, forward the new QoS level to AMF/MME 210 as SM policy update message 260. AMF/MME 210 may then forward the new QoS level to gNB/eNB 205, via new QoS message 262, for implementation and enforcement. Since the new QoS level is derived from gNB/eNB's 205 capacity-based recommendation, gNB/eNB 205 is assured of having the necessary resources to support the new QoS level.

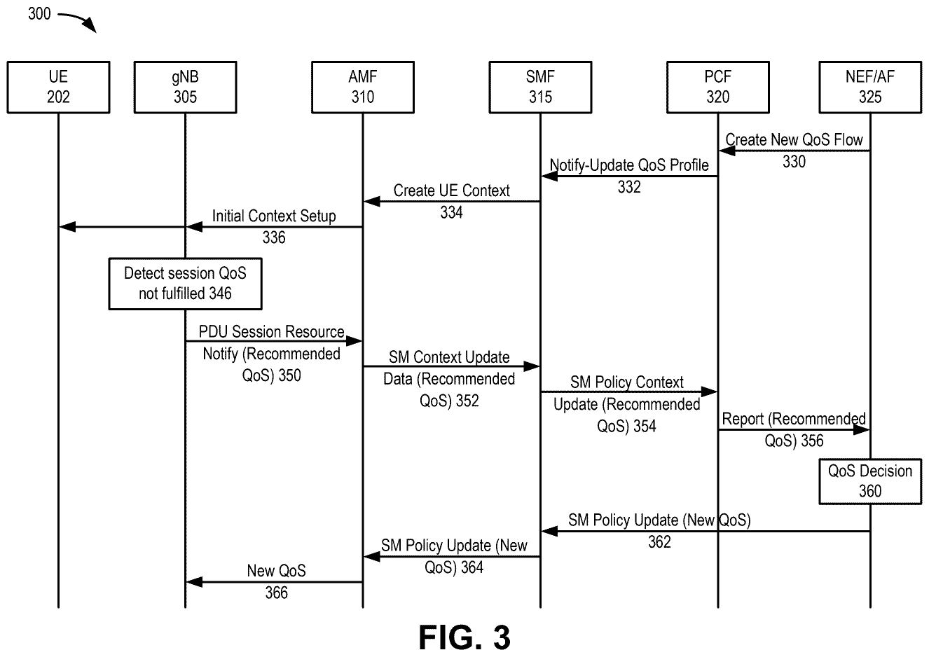

FIG. 3 is a message diagram illustrating an exemplary process 300 of an embodiment of the QoS adjustment service. Process 300 describes messages relating to adjusting the QoS level of a dedicated flow for a PDU session. As illustrated, process 300 may involve exemplary network devices, such as gNB 305, AMF 310, SMF 315, PCF 320, and an NEF/AF 325. Process 300 may further involve UE 202. NEF/AF 325 is a simplified representation of an NEF and an AF. The NEF may correspond to one of core devices 125. The AF may correspond to a core device 125 or an external device 135. According to other embodiments, process 300 may involve fewer, different, or additional network devices.

UE 202, gNB 305, AMF 310, SMF 315, PCF 320, and NEF/AF 325 may each include logic that performs an operation or provides a function that is in accordance with a technical specification associated with a network standardizing body. According to some embodiments, UE 202, gNB 305, AMF 310, SMF 315, PCF 320, and NEF/AF 325, or a sub-combination thereof, may be configured with logic that provides a proprietary operation or function not specified by the network standard. Additionally, gNB 305, AMF 310, SMF 315, PCF 320, and/or NEF/AF 325 may each include logic of the QoS adjustment service, as described herein.

The NEF of NEF/AF 325 exposes an Application Programming Interface (API) to devices outside core network 120 for requesting particular services within core network 120. For example, an application server (e.g., one of eternal devices 135) may, via the AF of NEF/AF 325 in core network 120, access the API of the NEF to provision a rule in the core network to apply a policy to a data flow associated with the application server. As an example, the application server may dynamically request to assign packets associated with an application identifier to a selected QoS class.

Referring to FIG. 3, after an initial registration and/or attachment procedure (not shown), NEF/AF 325 may provide to PCF 320 a create new QoS flow message 330 to form a data flow with one or more specified requirements. The request may include, for example, a QoS profile with information identifying a QoS Flow ID (QFI), a 5 QI to be assigned to the created data flow, and a request trigger for indicating when the assigned QoS parameters are not met.

PCF 320 may receive message 330 and determine/confirm the QoS level for the QoS profile. PCF 320 may provide a notify-update QoS profile message 332 to SMF 315. Notify-update QoS profile message 332 may include the QoS profile with the policy control request trigger for indicating when the assigned QoS parameters are not met (e.g., PolicyControlRequestTrigger=QoS_Notif).

SMF 315 may receive message 332 and may direct a session setup with AMF 310 and gNB 305. For example, SMF 315 may forward to AMF 310 a create UE context message 334 that includes the session (PDU Session ID=1) and the QoS profile. For example, the message 334 may be in the form of an HTTP POST message (e.g., POST../namf-comm/v./ue-contexts/{ueContextId}/n1-n2-messages). In one implementation, message 334 may include an information element (IE) with N2 SM information for the QoS profile (e.g., PDU Session Resource Setup Request Transfer IE (PDU Session ID=1, QFI=5, QoS Profile)).

AMF 310 may receive message 334 and, in response, establish a session. For example, AMF 310 may provide an initial context setup message 336 including an IE with the QoS profile (e.g., PDU Session Resource Setup Request Transfer IE (PDU Session ID=1, QFI=5, QoS Profile)). The gNB 305 may establish the session/flow with UE 202 and may facilitate the session according to the assigned QoS profile.

Once the session/flow is established, gNB 305 ensures that the assigned QoS from NEF/AF 325 is applied to the QoS flow. At some point after the QoS flow is established, gNB 305 may determine that it cannot fulfill the original assigned QoS, as indicated at reference 346. Accordingly, gNB 305 may generate and send a session resource notify message 350 to AMF 310. Similar to message 250 described above, session resource notify message 350 may include an IE to identify the current QFI for the session (e.g., QFI=5), a notification cause (e.g., QoS not fulfilled), and a recommended QoS that can be supported by the gNB (e.g., Recommend QoS of 5 QI=7, instead of the originally assigned 5 QI=5). In other implementations, gNB 305 may recommend a different QoS level (e.g., a drop of multiple 5 QI levels). Messages 352 and 354 may forward the notification from AMF 310 to SMF 315 to PCF 320 in a manner similar to messages 252 and 254 described above.

PCF 320 may provide to NEF/AF 325 a report 356 with the notification cause (e.g., QoS not fulfilled) and the recommended QoS (e.g., Recommend QoS=(5 QI=7) that can be supported by gNB 305. NEF/AF 325 may receive report 356 and, in response, make a decision 360 to adjust the QoS for the QoS flow. NEF/AF 325 can make the decision to either terminate the existing session or update the QoS of the existing QoS flow to a lower quality. According to implementations described herein, when electing to update the QoS level of the existing QoS flow, NEF/AF 325 may take into account the recommended QoS level provided by gNB 305 (e.g., 5 QI=7). For example, NEF/AF 325 may assign a new QoS value that indicates an equal or lower priority than the QoS level recommended by gNB 305. Thus, NEF/AF 325 may make an informed decision when adjusting the QoS for the QoS flow. Messages 362, 364, and 366 may forward the new QoS decision from NEF/AF 325 to SMF 315 to AMF 310 to gNB 305 in a manner similar to messages 258, 260, and 262 described above. Since the new QoS level is derived from gNB's 305 capacity-based recommendation, gNB 305 is assured of having the necessary resources to support the new QoS level.

FIGS. 2 and 3 illustrate exemplary processes 200 and 300, however, according to other embodiments and scenarios, processes 200/300 may include additional or fewer operations, and different operations, or a sub-combination thereof, and/or additional messages or fewer messages, and different messages, or a sub-combination thereof, depending on the context.

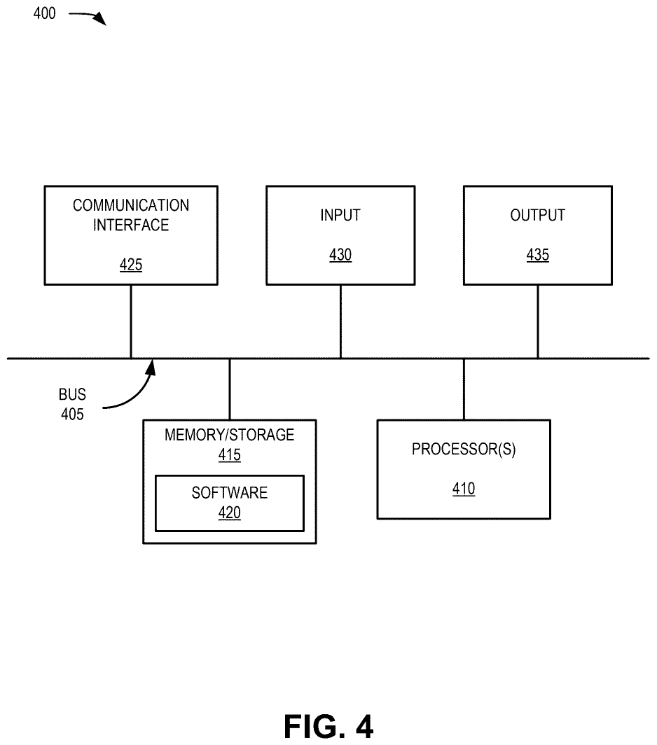

FIG. 4 is a diagram illustrating exemplary components of a device that may correspond to one or more of the devices illustrated and described herein. For example, device 400 may correspond to access device 115, core device 125, external device 135, end device 150, gNB/eNB 205, AMF/MME 210, SMF/PGW 215, PCF/PCRF 220, NEF/AF 325, and/or other types of devices, as described herein. As illustrated in FIG. 4, device 400 includes a bus 405, a processor 410, a memory/storage 415 that stores software 420, a communication interface 425, an input 430, and an output 435. According to other embodiments, device 400 may include fewer components, additional components, different components, and/or a different arrangement of components than those illustrated in FIG. 4 and described herein.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), quantum processors, future generation processors or execution environments, and/or some other type of component that interprets and/or executes instructions and/or data. Processor 410 may be implemented as hardware (e.g., a microprocessor, etc.), a combination of hardware and software (e.g., a SoC, an ASIC, etc.), may include one or multiple memories (e.g., cache, etc.), etc.

Processor 410 may control the overall operation, or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a network, another device, etc.). Processor 410 may perform an operation and/or a process based on various techniques and/or technologies including, for example, multithreading, parallel processing, pipelining, interleaving, machine learning, artificial intelligence, etc.

Memory/storage 415 includes one or multiple memories and/or one or multiple other types of storage mediums. For example, memory/storage 415 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory, a solid state memory, and/or some other type of memory. Memory/storage 415 may include a hard disk (e.g., a magnetic disk, an optical disk, a solid-state component, etc.), a Micro-Electromechanical System (MEMS)-based storage medium, and/or a nanotechnology-based storage medium.

Memory/storage 415 may be external to and/or removable from device 400, such as, for example, a Universal Serial Bus (USB) memory stick, a dongle, a hard disk, a solid state drive, mass storage, off-line storage, cloud storage, or some other type of storing medium. Memory/storage 415 may store data, software, and/or instructions related to the operation of device 400.

Software 420 includes an application or a program that provides a function and/or a process. As an example, with reference to gNB/eNB 205, software 420 may include an application that, when executed by processor 410, provides a function and/or a process of the QoS adjustment service, as described herein. Additionally, with reference to AMF/MME 210, SMF/PGW 215, PCF/PCRF 220, NEF/AF 325, and/or other core devices 125, software 420 may include an application that, when executed by processor 410, configures processor 410 to provide a function and/or a process of the QoS adjustment service or supports the process of the QoS adjustment service, as described herein. Software 420 may also include firmware, middleware, microcode, hardware description language (HDL), and/or other form of instruction. Software 420 may also be virtualized. Software 420 may further include an operating system.

Communication interface 425 permits device 400 to communicate with other devices, networks, systems, and/or the like. Communication interface 425 includes one or multiple wireless interfaces, optical interfaces, and/or wired interfaces. For example, communication interface 425 may include one or multiple transmitters and receivers, or transceivers. Communication interface 425 may operate according to a protocol stack and a communication standard.

Input 430 permits an input into device 400. For example, input 430 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 435 permits an output from device 400. For example, output 435 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 400 may be implemented in the same manner. For example, device 400 may be instantiated, created, spun-up, uninstantiated, deleted, spun-down, or placed in some other operational state during its life cycle (e.g., refreshed, paused, suspended, rebooting, or another type of state or status), using well-known virtualization technologies. For example, access device 115, core device 125, external device 135, and/or another type of network device or end device 150, as described herein, may be a virtualized device.

Device 400 may perform a process and/or a function, as described herein, in response to processor 410 executing software 420 stored by memory/storage 415. By way of example, instructions may be read into memory/storage 415 from another memory/storage 415 (not shown) or read from another device (not shown) via communication interface 425. The instructions that are stored by memory/storage 415 may configure and cause processor 410 to perform a function or a process described herein. Alternatively, for example, according to other implementations, device 400 performs a function or a process described herein based on the execution of hardware (processor 410, etc.).

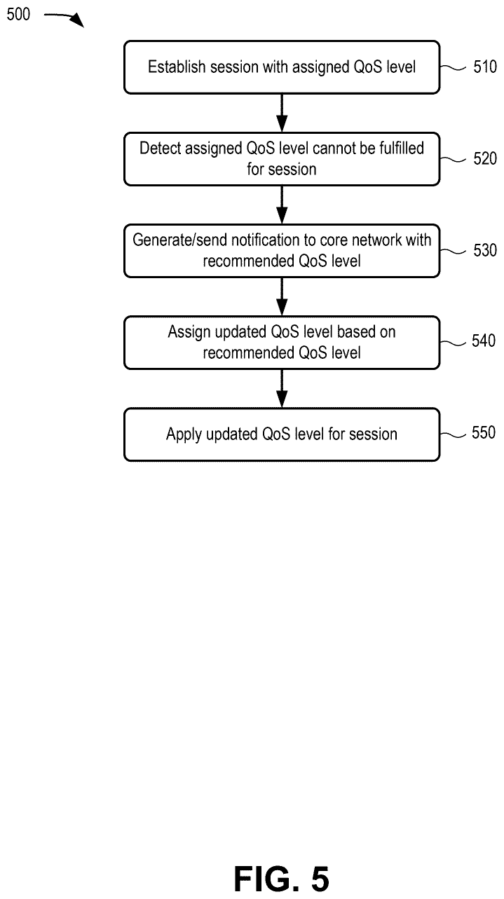

FIG. 5 is a flow diagram illustrating an exemplary process 500 of an embodiment of the QoS adjustment service. According to an embodiment, an access device 115 (such as gNB/eNB 205) and a core device (such as PCF/PCRF 220) may perform steps of process 500. According to an implementation, processor 410 executes software 420 to perform a step of process 500, as described herein. Alternatively, a step may be performed by execution of only hardware.

Process 500 may include establishing a session with an assigned QoS level (block 510) and detecting that the assigned QoS level cannot be fulfilled (block 520). For example, as shown in FIG. 2, a PDU/PDN session may be established when gNB/eNB 205 provides session establishment accept message 242. At some point after the session is established, gNB/eNB 205 may determine that it cannot fulfill the assigned QoS for the session, as indicated at reference 246.

Process 500 may further include generating and sending a notification to a core network with a recommended QoS level (block 530). For example, gNB/eNB 205 may identify a QoS level for the session that can be supported under the conditions (e.g., network load conditions). As indicated at message 250 of FIG. 2, gNB/eNB 205 may send a notification that includes a recommended QoS level that gNB/eNB 205 can support. In one implementation, the recommended QoS may be included in an IE for a PDU session resource notify transfer message.

Process 500 may also include assigning an updated QoS level based on the recommended QoS level (block 540) and applying the updated QoS level (block 550). For example, the recommended QoS level from message 250 may be eventually passed to PCF/PCRF 220 in core network 120. As shown at block 256 of FIG. 2, PCF/PCRF 220 may determine if the recommended QoS level is acceptable (e.g., consistent with user subscription, permitted by network policy, etc.) and provide instructions (e.g., message 258) with an updated QoS level for the session. The instructions may be received and implemented by gNB/eNB 205, which may apply the updated QoS level for the session.

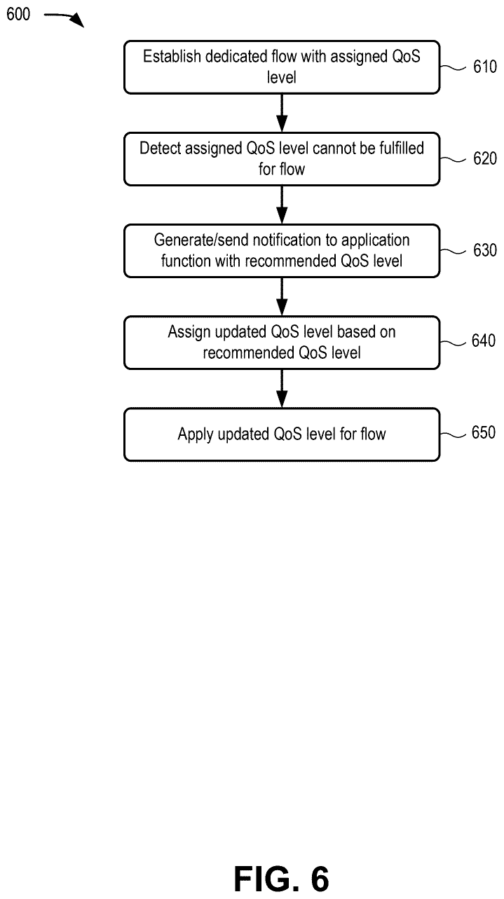

FIG. 6 is a flow diagram illustrating an exemplary process 600 of another embodiment of the QoS adjustment service. According to an embodiment, an access device 115 (such as gNB 305) and an external device (such as NEF/AF 325) may perform steps of process 600. According to an implementation, processor 410 executes software 420 to perform a step of process 600, as described herein. Alternatively, a step may be performed by execution of only hardware.

Process 600 may include establishing dedicated flow with an assigned QoS level (block 610) and detecting that the assigned QoS level cannot be fulfilled (block 620). For example, as shown in FIG. 3, a QoS flow may be established when gNB 305 receives and forwards initial context setup message 336. At some point after the QoS flow is established, gNB 305 may determine that it cannot fulfill the assigned QoS for the flow, as indicated at reference 346.

Process 600 may further include generating and sending a notification to a core network with a recommended QoS level (block 630). For example, gNB 305 may identify a QoS level for the flow that can be supported under the conditions (e.g., network load conditions). As indicated at message 350 of FIG. 3, gNB 305 may send a notification that includes a recommended QoS level that gNB 305 can support. In one implementation, the recommended QoS level may be included in an IE for a PDU session resource notify transfer message.

Process 600 may also include assigning an updated QoS level based on the recommended QoS level (block 640) and applying the updated QoS level (block 650). For example, the recommended QoS level from message 350 may be eventually passed to NEF/AF network 325. As shown at block 360 of FIG. 3, the AF may determine if the recommended QoS level is acceptable (e.g., consistent with a user subscription, adequate for an application, etc.) and provide instructions (e.g., message 362) with an updated QoS level for the flow. The instructions may be received and implemented by gNB 305, which may apply the updated QoS level for the flow.

FIGS. 5 and 6 illustrate exemplary processes 500 and 600 of the QoS adjustment service, according to other embodiments, the QoS adjustment service may perform additional operations, fewer operations, and/or different operations than those illustrated and described.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations. The term “substantially” is used herein to represent a degree by which a quantitative representation may vary from a stated reference without resulting in a change in the basic function of the subject matter at issue.

In addition, while series of blocks have been described regarding the processes illustrated in FIGS. 5 and 6, the order of the blocks may be modified according to other embodiments. Further, non-dependent blocks may be performed in parallel. Additionally, other processes described in this description and illustrated in the drawings may be modified and/or non-dependent operations may be performed in parallel.

Embodiments described herein may be implemented in many different forms of software executed by hardware. For example, a process or a function may be implemented as “logic” or a “component.” The logic or the component may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be used.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later become known are expressly incorporated herein by reference and are intended to be encompassed by the claims.

What is claimed is:

1. A method comprising:
determining, by an access device in an access network, that an assigned quality of service (QoS) level for a session or flow cannot be fulfilled;
sending, by the access device and to a network device, a notification message with a recommended QoS level that can be supported by the access device; and
receiving, by the access device and from the network device, an updated QoS level for the session or flow based on the recommended QoS level.

2. The method of claim 1, further comprising:
assigning, by the network device, an updated QoS level for the session based on the recommended QoS level.

3. The method of claim 2, wherein the network device includes one of a policy control function (PCF) or a policy and charging rules function (PCRF).

4. The method of claim 1, further comprising:
identifying, by the access device, the recommended QoS level for the session that can be supported by the access device.

5. The method of claim 1, wherein determining that the assigned QoS level for the session cannot be fulfilled includes:
determining that the assigned QoS level for a protocol data unit (PDU) session cannot be supported, or determining that the assigned QoS level for a packet data network (PDN) session cannot be supported.

6. The method of claim 1, wherein determining that the assigned QoS level for the session cannot be supported includes:
determining that the assigned QoS level for a dedicated flow of the session cannot be supported.

7. The method of claim 1, wherein sending the notification message with the recommended QoS level includes:
sending a 5G QoS Identifier (5 QI) or a QoS Class Identifier (QCI).

8. The method of claim 1, wherein sending the notification message with the recommended QoS level includes:
sending an Allocation and Retention Priority (ARP) level, or
load information indicative of a current capability of the access device to support the session or flow.

9. The method of claim 1, wherein the access device includes a next-generation NodeB (gNB) or an evolved NodeB (eNB).

10. The method of claim 1, wherein sending the notification message with the recommended QoS level includes:
providing the recommended QoS level as an information element of the notification message.

11. An access device, comprising:
a processor that is configured to:
determine that an assigned quality of service (QoS) level for a session or flow cannot be fulfilled by an access network;
send, to a network device, a notification message with a recommended QoS level that can be supported by the access device; and
receive, from the network device, an updated QoS level for the session or flow based on the recommended QoS level.

12. The access device of claim 11, wherein the processor is further configured to:
apply the updated QoS level for the session or flow.

13. The access device of claim 11, wherein the processor is further configured to:
identify the recommended QoS level for the session that can be supported by the access device.

14. The access device of claim 11, wherein, when determining that the assigned QoS level cannot be fulfilled, the processor is further configured to:
determine that the assigned QoS level for a protocol data unit (PDU) session cannot be supported, or
determine that the assigned QoS level for a packet data network (PDN) session cannot be supported.

15. The access device of claim 11, wherein, when determining that the assigned QOS level cannot be fulfilled, the processor is further configured to:
determine that the assigned QoS level for a dedicated flow of the session cannot be supported by the access device.

16. The access device of claim 11, wherein the recommended QoS level includes one of a 5G QoS Identifier (5 QI) or a QoS Class Identifier (QCI).

17. The access device of claim 11, wherein the recommended QoS level includes:
an Allocation and Retention Priority (ARP) level, or
load information indicative of a current capability of the access device to support the session or flow.

18. A non-transitory computer-readable storage medium storing instructions executable by a processor of an access device, wherein the instructions are configured to:
determine that an assigned quality of service (QoS) level for a session or flow cannot be fulfilled by an access network;
send, to a network device in a core network, a notification message with a recommended QoS level that can be supported by the access device; and
receive, from the network device, an updated QoS level for the session or flow based on the recommended QoS level.

19. The non-transitory computer-readable storage medium of claim 18, wherein the instructions are further configured to:
identify, before sending the notification message, the recommended QoS level for the session that can be supported by the access device; and
apply, after receiving the updated QoS level, the updated QoS level for the session or flow.

20. The non-transitory computer-readable storage medium of claim 18, wherein the session includes one of a protocol data unit (PDU) session or a packet data network (PDN) session, and wherein the recommended QoS level includes one of a 5G QoS Identifier (5 QI) or a QoS Class Identifier (QCI).
